(19) United States
(12) Patent Application Publication
(10) Pub. No.: US 2005/0110892 A1
(43) Pub. Date: May 26, 2005

(54) Image processing device and method, and image forming apparatus and image capturing apparatus including an image processing device

(75) Inventor: Tae-Lung Yun, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/990,408

(22) Filed: Nov. 18, 2004

(30) Foreign Application Priority Data
Nov. 20, 2003 (KR) 2003-82654

(51) Int. Cl. H04N 5/232; G03B 3/10; G03B 13/34; G03B 13/00; G06K 9/40

(52) U.S. Cl. 348/354; 382/255

(57) ABSTRACT

An image processing device and method in which only an image or part(s) of an image in adequate focus may be printed through an image forming apparatus such as a printer, are provided. The image processing device includes a focus determiner for determining whether a focus accuracy of an image displayed on a display unit is greater than a predetermined focus accuracy, and a focus processor for processing the image to be printed only if it is determined that the focus accuracy of the image is greater than the predetermined focus accuracy.

### PRIORITY

This application claims the benefit under 35 U.S.C. 119(a) of Korean Patent Application No. 2003-82654, filed on Nov. 20, 2003, in the Korean Intellectual Property Office, the entire contents of which is incorporated herein by reference.

### BACKGROUND OF THE INVENTION

1. Field of the Invention

The present invention relates to an image processing device. More particularly, the present invention relates to an image forming apparatus and an image capturing apparatus including the image processing device that allows only images or parts of images that are adequately in focus to be printed.

2. Description of the Related Art

An image forming apparatus, that is, a printer, includes a connection interface unit for connecting to a predetermined external device such as an image capturing apparatus (for example, a digital camera), and a memory interface unit for reading image data from a predetermined image storage device such as a memory card. FIG. 1 is a block diagram of a conventional image forming apparatus including a connection interface unit and a memory interface unit.

Referring to FIG. 1, an image forming apparatus 10 includes a controller 12, a display unit 14, operating panel equipment (OPE) 16, a memory 18, a print data processor 22, a print driver 24, a connection interface unit 32 for connecting the image forming apparatus 10 to an external device 2 such as a digital camera, and a memory interface unit 34 for reading image data stored in a memory device 4 such as a memory card. The controller 12 controls the operation of the image forming apparatus 10 using operating programs stored in the memory 18. The memory 18 stores program data, protocol data, character data and so forth. The data is input or output to or from the memory 18 under the control of the controller 12. The OPE 16 includes a plurality of keys which generate a key data signal. The key data generated by the OPE 16 is input to the controller 12. Generally, the display unit 14 comprising a Liquid Crystal Display (LCD) is incorporated into the OPE 16 and displays process results of various operations performed by the controller 12. The controller 12 reads image data from the memory device 4 via the memory interface unit 34 and image data from the external device 2 via the connection interface unit 32. The controller 12 also controls the print data processor 22 such that the image data is printed using the print driver 24.

The image forming apparatus 10 also includes a port 42 and a slot 44 for connecting the external device 2 and the memory device 4 to the connection interface unit 32 and the memory interface unit 34, respectively. The image received from the external device 2 connected to the port 42 and the image received from the memory device 4 inserted in the slot 44 may be printed by the image forming apparatus 10.

Hereinafter, the printing procedures of the image forming apparatus 10 will be described with reference to FIG. 1. The controller 12 determines whether the image data stored in the external device 2 or the image data stored in the memory device 4 is input to the interface unit 32 or 34 via the port 42 or the slot 44, respectively. For example, if the memory device 4 such as a memory card in which a plurality of images are stored is inserted in the slot 44, the controller 12 reads the images from the memory device 4, and displays the images on the display unit 14. For the images displayed on the display unit 14, a user issues an index print command or, after selecting one of the images, issues a print command for printing the selected image. If the print command is issued, the image data corresponding to the print command is input to the controller 12 via the slot 44 and the memory interface unit 34 from the memory device 4. When the image data has been input to the controller 12, the controller 12 controls the print data processor 22 such that the input image data is printed using the print driver 24.

Similarly, if the external device 2 such as a digital camera is connected to the connection interface unit 32 via the port 42, the controller 12 reads the images from the external device 2, and displays the images on the display unit 14 or on the display unit (not shown) of the external device 2. When the images are displayed on the display unit 14, a user can issue an index print command or, after selecting one of the images, issues a print command for printing the selected image. If the print command is issued, the image data corresponding to the print command is input to the controller 12 via the port 42 and the connection interface unit 32 from the external device 2. When the image data has been input to the controller 12, the controller 12 controls the print data processor 22 such that the input image data is printed using the print driver 24.

However, in a display unit of an image capturing apparatus such as a digital camera used as an external device and in a display unit of an image forming apparatus, a screen of each display unit is so small that it is difficult to determine how well focused the displayed image is on the screen.

Therefore, when printing the displayed image on the screen using the image forming apparatus, print quality may not be good. That is, since it is difficult to determine whether the image displayed on the screen of each display unit embedded in a conventional image capturing apparatus and a conventional image forming apparatus has been captured with accurate focus, it is likely that a displayed image which has been captured and not in focus will be selected to be printed. Therefore resources such as paper, toner, power and so forth may be used inefficiently because the displayed image may result in a low quality image.

### SUMMARY OF THE INVENTION

Accordingly, the embodiments of the present invention have been made to solve the above-mentioned problems occurring in the prior art and to provide other advantages. An object of the present invention is to provide an image processing device in which only an image or part(s) of an image in adequate focus are printed through an image forming apparatus such as a printer.

Embodiments of the present invention also provide an image processing method in which only an image or part(s) of an image in adequate focus may be printed through an image forming apparatus such as a printer.

Embodiments of the present invention also provide an image forming apparatus employing the image processing device.

Embodiments of the present invention also provide an image capturing apparatus employing the image processing device.

According to an aspect of the present invention, there is provided an image processing device for processing predetermined images. The image processing device includes a focus determiner for determining whether the focus accuracy of an image displayed on a display unit is higher than a predetermined focus accuracy, and a focus processor for processing the image to be printed only if it is determined that the focus accuracy of the image is greater than the predetermined focus accuracy.

Preferably, the image processing device can include an image divider for dividing the image displayed on the display unit into a plurality of areas, an image selector for selecting some of the areas, a high pass filter for acquiring high frequency signals of the image, an energy value calculator for calculating an energy value of the high frequency signals acquired by the high pass filter, and a focus determination result indicator for indicating a result determined by the focus determiner. When the energy value is greater than a predetermined energy value, the focus determiner determines that the focus accuracy of the image is greater than the predetermined focus accuracy.

Preferably, the energy value calculator can calculate the energy value using Fast Fourier transform (FFT).

Preferably, the image processing device can include modules embedded in an image forming apparatus or an image capturing apparatus.

According to another aspect of the present invention, there is provided an image forming apparatus for printing images. The image forming apparatus includes a focus determiner for determining whether a focus accuracy of an image displayed on a display unit is higher than a predetermined focus accuracy, a focus processor for processing the image to be printed if it is determined that the focus accuracy of the image is greater than the predetermined focus accuracy, a high pass filter for acquiring high frequency signals of the image, and an energy value calculator for calculating an energy value of the high frequency signals. Here, when the energy value is greater than a predetermined energy value, the focus determiner determines that the focus accuracy of the image is greater than the predetermined focus accuracy.

According to another aspect of the present invention, there is provided an image capturing apparatus for capturing images. The image capturing apparatus includes a focus determiner for determining whether focus accuracy of an image displayed on a display unit is greater than a predetermined focus accuracy, a focus processor for processing the image to be printed if it is determined that the focus accuracy of the image is greater than the predetermined focus accuracy, a high pass filter for acquiring high frequency signals of the image, and an energy value calculator for calculating an energy value of the high frequency signals. Here, when the energy value is greater than a predetermined energy value, the focus determiner determines that the focus accuracy of the image is greater than the predetermined focus accuracy.

According to another aspect of the present invention, there is provided a method of processing predetermined images. The method includes determining whether a focus accuracy of an image displayed on a display unit is higher than a predetermined focus accuracy, processing the image to be printed if it is determined that the focus accuracy of the image is greater than the predetermined focus accuracy, acquiring high frequency signals of the image, and calculating an energy value of the high frequency signals. When the energy value is greater than a predetermined energy value, it is determined in the determining operation that the focus accuracy of the image is greater than the predetermined focus accuracy.

Preferably, the method can include dividing the image displayed on the display unit into a plurality of areas, selecting some of the areas, and informing a user of results determined in the determining step.

### BRIEF DESCRIPTION OF THE DRAWINGS

The above and/or other features and advantages of the present invention will become more apparent by describing in detail exemplary embodiments thereof with reference to the attached drawings in which:

FIG. 1 is a block diagram of a conventional image forming apparatus;

FIG. 2 is a block diagram of an image processing device according to an embodiment of the present invention;

FIG. 3 is a block diagram of an image forming apparatus including the image processing device of FIG. 2;

FIG. 4 is a block diagram of an image capturing apparatus including the image processing device of FIG. 2;

FIG. 5 is a flowchart illustrating an image processing method according to an embodiment of the present invention;

FIG. 6A is a schematic diagram of divided areas selected by the image processing device;

FIG. 6B is a schematic diagram of an area freely selected by the image processing device; and

FIG. 6C is a schematic diagram of an area to be wholly selected by the image processing device.

Throughout the drawings, it should be noted that like reference numbers are used to depict the same or similar elements, features and structures are denoted by like reference numerals.

### DETAILED DESCRIPTION OF EXEMPLARY EMBODIMENTS

Hereinafter, the present invention will be described more fully with reference to the accompanying drawings in which exemplary embodiments of the invention are shown. In this disclosure, detailed descriptions of conventional techniques and conventional structures are omitted for conciseness. In addition, all terms mentioned throughout this disclosure are defined based on the functions of what they represent in the embodiments of the present invention, and thus their definitions may vary depending on the users' intent or custom. Therefore, those terms should be defined based on the content presented here in the present disclosure.

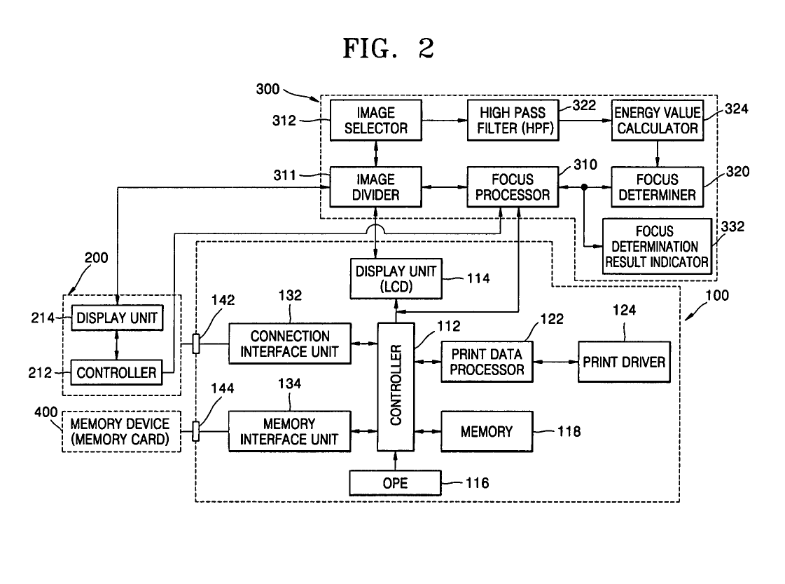

FIG. 2 is a block diagram of an image processing device according to an embodiment of the present invention. Referring to FIG. 2, an image processing device 300 is associated with an image forming apparatus 100 and/or an image capturing apparatus 200 in order to process images. The image processing device 300 includes a focus processor 310, an image divider 311, an image selector 312, a focus determiner 320, a high pass filter (HPF) 322, an energy value calculator 324, and a focus determination result indicator 332.

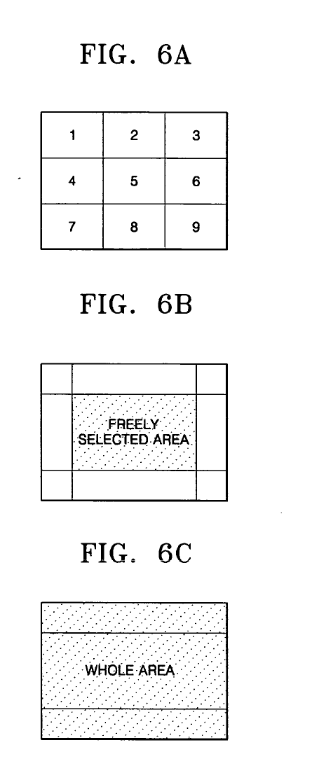

The focus determiner 320 determines whether a focus accuracy of an image displayed on a display unit 114 of the image forming apparatus 100 or a display unit 214 of the image capturing apparatus 200 is greater than a predetermined focus accuracy. The focus processor 310 processes the image to be printed through the image forming apparatus 100 only when it is determined that the focus accuracy of the image displayed by the display unit 114 or 214 is greater than the predetermined focus accuracy. The image divider 311 may divide the image displayed by the display unit 114 or 214 into a plurality of areas as shown in FIG. 6A. The predetermined area of the image is selected as shown in FIG. 6A through 6C by the image selector 312.

The HPF 322 allows high frequency signals of the image displayed by the display unit 114 or 214 to pass. The energy value calculator 324 calculates an energy value of the high frequency signals acquired by the HPF 322. The energy value calculator 324 uses Fast Fourier Transform (FFT) to calculate the energy value. The focus determination result indicator 332 indicates user results determined by the focus determiner 320 so that the user may recognize the results.

If the energy value calculated by the energy value calculator 324 is greater than a predetermined energy value, the focus determiner 320 determines that the focus accuracy of the image is greater than the predetermined focus accuracy, and then the image processing device 300 allows the image to be printed through the image forming apparatus 100. Therefore, the image processing device 300 according to an embodiment of the present invention processes images so that only images that are in focus may be printed, thus preventing inefficient use of resources.

As is known to those skilled in the art, elements of the image processing device 300 may comprise an appropriate combination of hardware and software. Here, for example, a software part of each element may be stored in a memory 118 of the image forming apparatus 100, and performed by a controller 112 of the image forming apparatus 100.

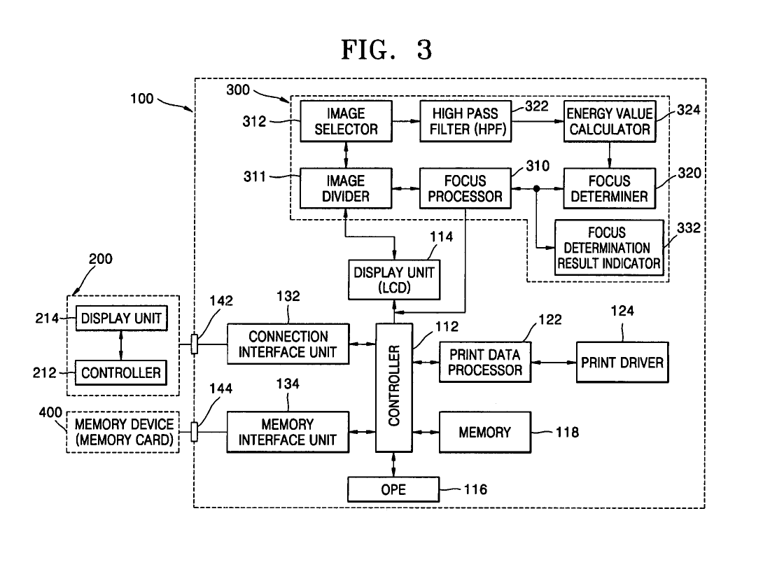

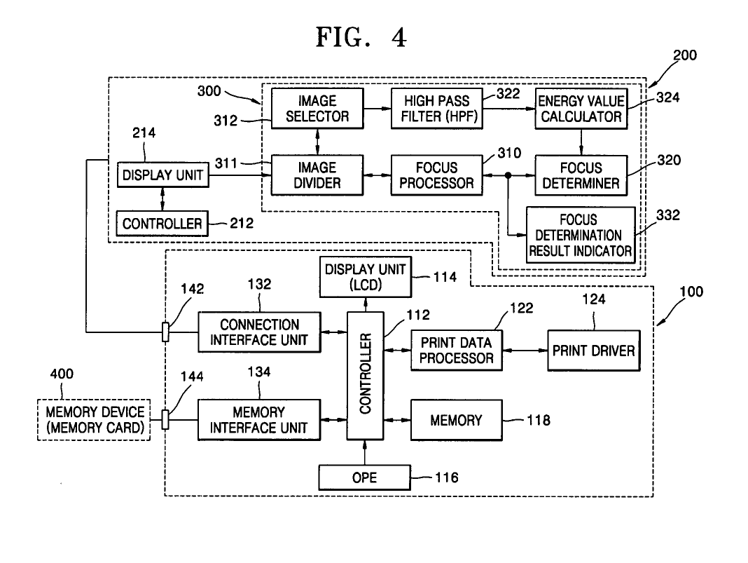

In the meantime, as shown in FIGS. 3 and 4, the image processing device 300 can comprise firmware modules embedded in the image forming apparatus 100 or the image capturing apparatus 200. When the image processing device 300 is embedded in the image capturing apparatus 200, the software part of each element of the image processing device 300 may be stored in a memory (not shown) of the image capturing apparatus 200, and performed by a controller 212 of the image capturing apparatus 200.

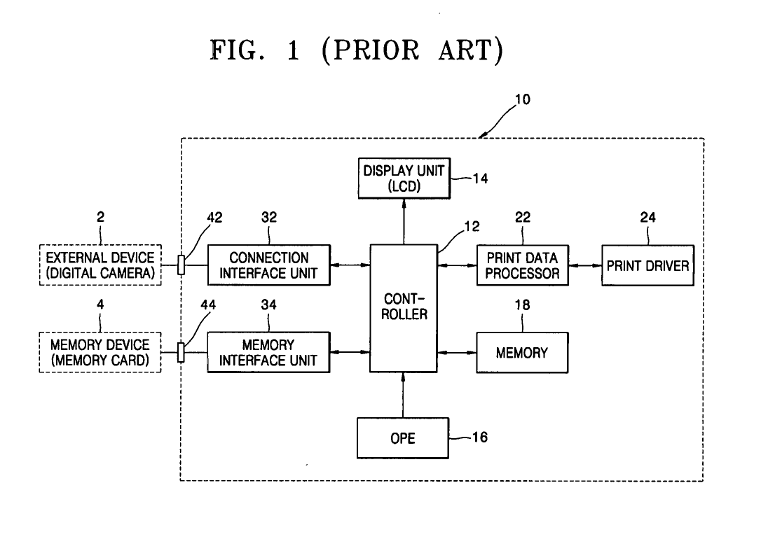

The image forming apparatus 100, is equivalent to the conventional image forming apparatus of FIG. 1, which prints the image determined and processed by the image processing device 300, includes a controller 112, a display unit 114 with a Liquid Crystal Display (LCD), operating panel equipment (OPE) 116, a memory 118, a print data processor 122, a print driver 124, a connection interface unit 132 connecting the image forming apparatus 100 to an external device or the image capturing apparatus 200 such as a digital camera, a memory interface unit 134 for reading image data stored in a memory device 400 such as a memory card, a port 142 for connecting the external device to the connection interface unit 132, and a slot 144 for connecting the memory device 400 to the memory interface unit 134. Programs associated with the software part of each element included in the image processing device 300 are stored in the memory 118, and performed by a controller 112 such that only images with a usable focus may be printed. Key buttons are arranged in the OPE 116 so that a user may confirm that the image has a usable focus.

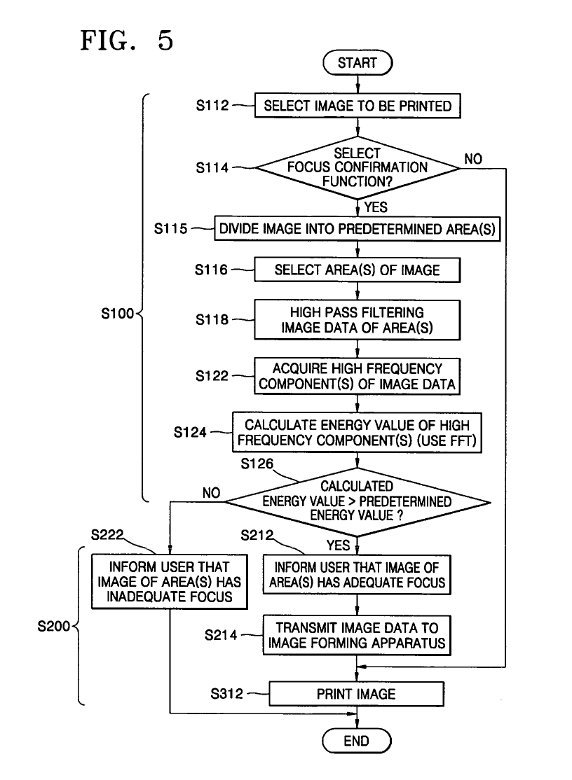

Hereinafter, an image processing method according to an embodiment of the present invention performed by the image processing device will be described with reference to FIG. 5. Referring to FIG. 5, the processing method may include determining whether a focus accuracy of an image displayed on the display unit 114 or 214 is greater than a predetermined focus accuracy at step S100, and processing the image to be printed through the image forming apparatus 100 if it is determined that the focus accuracy of the image is greater than the predetermined focus accuracy at step S200.

The determining step S100 may comprise, selecting an image to be printed from images stored in the image capturing apparatus 200 or the memory at step S112, determining whether a user selects a focus confirmation function through the OPE 116 at step S114, dividing the image displayed on the display unit into a plurality of areas at step S115, selecting some of the areas in order to determine the focus state of the image at step S116, high pass filtering to acquire high frequency signals of the image in the selected areas at steps S118 and S122, calculating an energy value of the high frequency signals at step S124, and determining whether the energy value of the high frequency signals is greater than a predetermined energy value at step S126.

The processing step S200 may comprise, if it is determined that the energy value is greater than the predetermined energy value at step S126, informing a user that the image is in adequate focus at step S212, transmitting data of the image to the image forming apparatus 100 at step S214, and printing the image through the image forming apparatus 100 at step S312. Also, the processing step S200 may include, if it is determined that the energy value is not greater than the predetermined energy value at step S126, informing the user that the image has inadequate focus at step S222. Preferably, at step S222, there may be a process to prevent the image from being printed.

An operation of a preferred embodiment of the present invention will be described with reference to FIGS. 5 and 6. Referring to FIGS. 5 and 6, at step S112, if a user selects an image to print using the OPE 116 of the image forming apparatus 100, the focus processor 310 and/or the controller 112 in FIG. 3 or 212 in FIG. 4 determines whether the user has selected a focus confirmation function at step S114. At step S114, if it is determined that the user has not selected the focus confirmation function, the image selected by the user is printed according to a conventional method at step S312. However, at step S114, if it is determined that the user has selected the focus confirmation function, the image divider 311 divides the selected image into predetermined areas, for example, nine areas as shown in FIG. 6A at step S115. At step S116, the user may select area(s) which to print among the divided areas shown in FIG. 6A, or a free area shown in FIG. 6B, or the whole area shown in FIG. 6C, using the image selector 312. At step S116, if the area(s) to be printed is selected by the user, image data of the area(s) is input to the HPF 322 and high pass filtered by the HPF 322, such that the HPF 322 allows high frequency components or signals of the image to pass at steps S118 and S122. At step S122, after the HPF 322 has allowed the high frequency components or signals of the image to pass, the energy value calculator 324 calculates an energy value of the high frequency components or signals using FFT at step S124. At step S124, after the energy value calculator 324 calculates the energy value, the focus determiner 320 determines whether the energy value is greater than a predetermined energy value at step S126.

At step S126, if it is determined that the energy value is greater than the predetermined energy value, the focus processor 310 controls the focus determination result indicator 332 or the display unit 114 or 214 so that a user is informed that the image has adequate focus at step S212. Then, the focus processor 310 transmits image data to the image forming apparatus 100 to print the image at step S214. At step S214, after the data for the image has been transmitted to the image forming apparatus 100, the image is printed at step S312. However, at step S126, if it is determined that the energy value is not greater than the predetermined energy value, the focus processor 310 controls the focus determination result indicator 332 or the display unit 114 or 214 or a buzzer (not shown) such that the user is informed that the image has inadequate focus at step S222. Thereafter, the focus processor 310 may prevent the image from being printed so that resources such as paper and toner are not inefficiently used due to a printed image of poor quality.

As described above, according to embodiments of the present invention, a user is able to prevent inefficient use of resources, for example, paper for printing and toner or ink for printing, because an image forming apparatus such as a printer may print only images which are captured by an image capturing apparatus such as a digital camera and stored in storage media such as a memory card in adequate focus. In addition, a user is able to prevent inefficient use of resources, because the user may select only images which have adequate focus or only part(s) of the image which has (have) adequate focus and then print them.

Also, as described above, according to an embodiment of the present invention, since a user may determine the focus of images before printing, usage convenience of an image forming apparatuses can be improved.

Further, as described above, according to an embodiment of the present invention, a user may determine the focusing of images captured by an image capturing apparatuses, and usage convenience of an image capturing apparatuses can be improved.

While the present invention has been particularly shown and described with reference to exemplary embodiments thereof, it should be understood by those of ordinary skill in the art that various changes in form and details may be made therein without departing from the spirit and scope of the present invention as defined by the following claims.

1. An image processing device for processing images, the image processing device comprising:
a focus determiner for determining whether a focus accuracy of an image displayed on a display unit is greater than a predetermined focus accuracy; and
a focus processor for processing the image to be printed only if it is determined that the focus accuracy of the image is greater than the predetermined focus accuracy.

2. The image processing device of claim 1, further comprising:
an image divider for dividing the image displayed on the display unit into a plurality of areas; and
an image selector for selecting some of the areas.

3. The image processing device of claim 1, further comprising:
a high pass filter for acquiring high frequency signals for storing the image; and
an energy value calculator for calculating an energy value of the high frequency signals acquired using the high pass filter.

4. The image processing device of claim 3, wherein, when the energy value is greater than a predetermined energy value, the focus determiner determines that the focus accuracy of the image is greater than the predetermined focus accuracy.

5. The image processing device of claim 3, wherein the energy value calculator calculates the energy value using Fast Fourier Transform (FFT).

6. The image processing device of claim 1, further comprising:
a focus determination result indicator for indicating a result determined by the focus determiner.

7. The image processing device of claim 1, wherein the display unit is included in an image forming apparatus such as a printer.

8. The image processing device of claim 7, wherein the image processing device includes modules embedded in the image forming apparatus.

9. The image processing device of claim 1, wherein the display unit is included in an image capturing apparatus such as a digital camera.

10. The image processing device of claim 9, wherein the image processing device includes modules embedded in the image capturing apparatus such as a digital camera.

11. An image forming apparatus printing images, the image forming apparatus comprising:
a focus determiner for determining whether a focus accuracy of an image displayed on a display unit is greater than a predetermined focus accuracy;
a focus processor for processing the image to be printed if it is determined that the focus accuracy of the image is greater than the predetermined focus accuracy;
a high pass filter for acquiring high frequency signals for storing the image; and
an energy value calculator for calculating an energy value of the high frequency signals, wherein when the energy value is greater than a predetermined energy value, the focus determiner determines that the focus accuracy of the image is greater than the predetermined focus accuracy.

12. The image forming apparatus of claim 11, further comprising:
an image divider for dividing the image displayed on the display unit into a plurality of areas;
an image selector for selecting some of the areas; and
a focus determination result indicator for indicating a result determined by the focus determiner.

13. An image capturing apparatus for capturing images, the image capturing apparatus comprising:
a focus determiner for determining whether a focus accuracy of an image displayed on a display unit is greater than a predetermined focus accuracy;
a focus processor for processing the image to be printed if it is determined that the focus accuracy of the image is greater than the predetermined focus accuracy;
a high pass filter for acquiring high frequency signals for storing the image; and
an energy value calculator for calculating an energy value of the high frequency signals, wherein when the energy value is greater than a predetermined energy value, the focus determiner determines that the focus accuracy of the image is higher than the predetermined focus accuracy.

14. The image capturing apparatus of claim 13, further comprising:
an image divider for dividing the image displayed on the display unit into a plurality of areas;
an image selector for selecting some of the areas; and
a focus determination result indicator for indicating a result determined by the focus determiner.

15. A method of processing images, the method comprising:
determining whether a focus accuracy of an image displayed on a display unit is greater than a predetermined focus accuracy;
processing the image to be printed if it is determined that the focus accuracy of the image is greater than the predetermined focus accuracy;
acquiring high frequency signals of the image; and
calculating an energy value of the high frequency signals, wherein, when the energy value is greater than a predetermined energy value, it is determined in the determining step that the focus accuracy of the image is higher than the predetermined focus accuracy.

16. The method of claim 15, further comprising:
dividing the image displayed on the display unit into a plurality of areas;
selecting some of the areas; and
informing a user of results determined in the determining step.

17. The method of claim 15, wherein Fast Fourier Transform (FFT) is used in the calculating step.
